(19) United States
(12) Patent Application Publication
(10) Pub. No.: US 2002/0194790 A1
(43) Pub. Date: Dec. 26, 2002

(54) Method for fabricating diamond conditioning disc and disc fabricated

(75) Inventors: Ting-Chun Wang, Taoyuan (TW); Hsi-Kuei Cheng, Hsin Chu (TW); Yu-Ku Lin, Hsin-Chu City (TW); Yi-Lang Wang, Lung-Ching (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.,

(21) Appl. No.: 09/886,864

(22) Filed: Jun. 21, 2001

(51) Int. Cl. C09K 3/14; C09C 1/68

(52) U.S. Cl. 51/309

(57) ABSTRACT

A method for fabricating diamond conditioning disc and the disc fabricated are described. In the method, a substrate for a diamond conditioning disc is first provided, a layer of a binder material such as an alloy of nickel is then coated on top of the diamond conditioning disc, a plurality of diamond particles is then implanted in a layer of binder material such that not more than ⅔ of a diameter, or of a height of the multiplicity of diamond particles is exposed above a top surface of the layer of the binder material. In a preferred embodiment, the multiplicity of diamond particles is implanted in a layer of binder material such that between about ½ and about ⅔ of a diameter, or of a height of the particles is exposed, or protruded above a top surface of the binder material layer.

### FIELD OF THE INVENTION

The present invention generally relates to a conditioning disc used in a chemical mechanical polishing apparatus and more particularly, relates to a diamond conditioning disc wherein diamond particles are embedded such that the particles do not protrude above a top surface of a binder material more than ⅔ of the height (or diameter) of the particle to prevent the loss of particles during a polishing process.

### BACKGROUND OF THE INVENTION

Apparatus for polishing thin, flat semiconductor wafers is well not in the art. Such apparatus normally includes a polishing head which carries a membrane for engaging and forcing a semiconductor wafer against a wetted polishing surface, such as a polishing pad. Either the pad, or the polishing head is rotated and oscillates the wafer over the polishing surface. The polishing head is forced downwardly onto the polishing surface by a pressurized air system or, similar arrangement. The downward force pressing the polishing head against the polishing surface can be adjusted as desired. The polishing head is typically mounted on an elongated pivoting carrier arm, which can move the pressure head between several operative positions. In one operative position, the carrier arm positions a wafer mounted on the pressure head in contact with the polishing pad. In order to remove the wafer from contact with the polishing surface, the carrier arm is first pivoted upwardly to lift the pressure head and wafer from the polishing surface. The carrier arm is then pivoted laterally to move the pressure head and wafer carried by the pressure head to an auxiliary wafer processing station. The auxiliary processing station may include, for example, a station for cleaning the wafer and/or polishing head; a wafer unload station; or, a wafer load station.

More recently, chemical-mechanical polishing (CMP) apparatus has been employed in combination with a pneumatically actuated polishing head. CMP apparatus is used primarily for polishing the front face or device side of a semiconductor wafer during the fabrication of semiconductor devices on the wafer. A wafer is “planarized” or smoothed one or more times during a fabrication process in order for the top surface of the wafer to be as flat as possible. A wafer is polished by being placed on a carrier and pressed face down onto a polishing pad covered with a slurry of colloidal silica or alumina in de-ionized water.

A perspective view of a typical CMP apparatus is shown in FIG. 1A. The CMP apparatus 10 consists of a controlled mini-environment 12 and a control panel section 14. In the controlled mini-environment 12, typically four spindles 16, 18, 20, and 22 are provided (the fourth spindle 22 is not shown in FIG. 1a) which are mounted on a cross-head 24. On the bottom of each spindle, for instance, under the spindle 16, a polishing head 26 is mounted and rotated by a motor (not shown). A substrate such as a wafer is mounted on the polishing head 26 with the surface to be polished mounted in a face-down position (not shown). During a polishing operation, the polishing head 26 is moved longitudinally along the spindle 16 in a linear motion across the surface of a polishing pad 28. As shown in FIG. 1A, the polishing pad 28 is mounted on a polishing disc 30 rotated by a motor (not shown) in a direction opposite to the rotational direction of the polishing head 26.

Also shown in FIG. 1a is a conditioner arm 32 which is equipped with a rotating conditioner disc 34. The conditioner arm 332 pivots on its base 36 for conditioning the polishing pad 38 for the in-situ conditioning of the pad during polishing. While three stations each equipped with a polishing pad 28, 38 and 40 are shown, the fourth station is a head clean load/unload (HCLU) station utilized for the loading and unloading of wafers into and out of the polishing head. After a wafer is mounted into a polishing head in the fourth head cleaning load/unload station, the cross head 24 rotates 90° clockwise to move the wafer just loaded into a polishing position, i.e., over the polishing pad 28. Simultaneously, a polished wafer mounted on spindle 20 is moved into the head clean load/unload station for unloading.

A cross-sectional view of a polishing station 42 is shown in FIGS. 1B and 1C. As shown in FIG. 1B, a rotating polishing head 26 which holds a wafer 44 is pressed onto an oppositely rotating polishing pad 28 mounted on a polishing disc 30 by adhesive means. The polishing pad 28 is pressed against the wafer surface 46 at a predetermined pressure. During polishing, a slurry 48 is dispensed in droplets onto the surface of the polishing pad 28 to effectuate the chemical mechanical removal of materials from the wafer surface 46.

An enlarged cross-sectional representation of the polishing action which results form a combination of chemical and mechanical effects is shown in FIG. 1C. The CMP method can be used to provide a planner surface on dielectric layers, on deep and shallow trenches that are filled with polysilicon or oxide, and on various metal films. A possible mechanism for the CMP process involves the formation of a chemically altered layer at the surface of the material being polished. The layer is mechanically removed from the underlying bulk material. An outer layer is then regrown on the surface while the process is repeated again. For instance, in metal polishing, a metal oxide layer can be formed and removed repeatedly.

During a CMP process, a large volume of a slurry composition is dispensed. The slurry composition and the pressure applied between the wafer surface and the polishing pad determine the rate of polishing or material removal from the wafer surface. The chemistry of the slurry composition plays an important role in the polishing rate of the CMP process. For instance, when polishing oxide films, the rate of removal is twice as fast in a slurry that has a pH of 11 than with a slurry that has a pH of 7. The hardness of the polishing particles contained in the slurry composition should be about the same as the hardness of the film to be removed to avoid damaging the film. A slurry composition typically consists of an abrasive component, i.e, hard particles and components that chemically react with the surface of the substrate. For instance, a typical oxide polishing slurry composition consists of a colloidal suspension of oxide particles with an average size of 30 nm suspended in an alkali solution at a pH larger than 10. A polishing rate of about 120 nm/min can be achieved by using this slurry composition. Other abrasive components such as ceria suspensions may also be used for glass polishing where large amounts of silicon oxide must be removed. Ceria suspensions act as both the mechanical and the chemical agent in the slurry for achieving high polishing rates, i.e, larger than 500 nm/min. While ceria particles in the slurry composition remove silicon oxide at a higher rate than do silica, silica is still preferred because smoother surfaces can be produced. Other abrasive components, such as alumina (Al₃O₂)may also be used in the slurry composition.

The polishing pad 28 is a consumable item used in a semiconductor wafer fabrication process. Under normal wafer fabrication conditions, the polishing pad is replaced after about 12 hours of usage. Polishing pads may be hard, incompressible pads or soft pads. For oxide polishing, hard and stiffer pads are generally used to achieve planarity. Softer pads are generally used in other polishing processes to achieve improved uniformity and smooth surface. The hard pads and the soft pads may also be combined in an arrangement of stacked pads for customized applications.

A problem frequently encountered in the use of polishing pads in oxide planarization is the rapid deterioration in oxide polishing rates with successive wafers. The cause for the deterioration is known as “pad glazing” wherein the surface of a polishing pad becomes smooth such that the pad no longer holds slurry in-between the fibers. This is a physical phenomenon on the pad surface not caused by any chemical reactions between the pad and the slurry.

To remedy the pad glazing effect, numerous techniques of pad conditioning or scrubbing have been proposed to regenerate and restore the pad surface and thereby, restoring the polishing rates of the pad. The pad conditioning techniques include the use of silicon carbide particles, diamond emery paper, blade or knife for scrapping the polishing pad surface. The goal of the conditioning process is to remove polishing debris from the pad surface, re-open the pores, and thus forms micro-scratches in the surface of the pad for improved life time. The pad conditioning process can be carried out either during a polishing process, i.e. known as concurrent conditioning, or after a polishing process.

While the pad conditioning process improves the consistency and lifetime of a polishing pad, a conventional conditioning disk is frequently not effective in conditioning a pad surface after repeated usage. A conventional conditioning disk for use in pad conditioning is shown in FIGS. 2A and 2B.

Referring now to FIG. 2A, wherein a perspective view of a CMP publishing station 42 is shown. The polishing station 42 consists of a conditioning head 52, a polishing pad 28, and a slurry delivery arm 54 positioned over the polishing pad. The conditioning head 52 is mounted on a conditioning arm 58 which is extended over the top of the polishing pad 28 for making sweeping motion across the entire surface of the pad. The slurry delivery arm 54 is equipped with slurry dispensing nozzles 62 which are used for dispensing a slurry solution on the top surface 60 of the polishing pad 56. Surface grooves 64 are further provided in the top surface 60 to facilitate even distribution of the slurry solution and to help entrapping undesirable particles that are generated by coagulated slurry solution or any other foreign particles which have fallen on top of the polishing pad during a polishing process. The surface grooves 64 while serving an important function of distributing the slurry also presents a processing problem when the pad surface 60 gradually worn out after successive use.

The conditioning disc 68, shown in FIG. 2B is formed by embedding or encapsulating diamond particles 50 in an alloy layer 56 of chromium and nickel coated on the surface 70 of a rigid substrate 22. FIG. 2B is a cross-sectional view of a new conditioning disk with all the diamond particles 50 embedded in the alloy layer 56. In the fabrication of the diamond particle conditioning disk 68, an alloy encapsulant 56 is first mixed with a diamond grit which includes diamond particles 50 and then applied to the rigid substrate 22. The conditioning disc 68 may further be fabricated by first coating the alloy layer 56 on a rigid substrate 22, and then implanting diamond particles in the alloy binder layer 56 such that the diamond particles 50 are only partially exposed.

After repeated usage of a diamond conditioning disc, diamond particles 50 may fall off the alloy binder layer 56, as shown in FIGS. 3A and 3B. When diamond particles become loose from the binder material layer, the particles become major source of contamination for the chemical mechanical process. For instance, when a large particle falls on the polishing disc, a serious scratch (known as a macro-scratch in the trade) 80 as shown in FIG. 3C, occurs. The macro scratch may be formed in an arcuate shape having a length as long as 8 inches and a depth as large as 3 μm. A semiconductor wafer that suffers a macro-scratch can not be salvaged and must be scrapped.

It is therefore an object of the present invention to provide a method for fabricating a diamond conditioning disc such that the disc does not have the drawbacks or shortcomings of the conventional discs.

It is another object of the represent invention to provide a method for fabricating a diamond conditioning disc that has substantially improved holding capability for the diamond particles.

It is a further object of the present invention to provide a method for fabricating a diamond conditioning disc for use in a chemical mechanical polishing apparatus that does not cause a macro-scratch defect on the wafer.

It is another further object of the present invention to provide a method for fabricating a diamond conditioning disc by implanting diamond particles in a binder material layer such that not more than ⅔ of a diameter of the particles is exposed above the binder material layer.

It is still another object of the present invention to provide a method for fabricating a diamond conditioning disc wherein diamond particles are embedded in a binder material layer with between ½ and ⅔ of a height of the diamond particle exposed above a top surface of the binder material layer.

It is yet another object of the present invention to provide a diamond conditioning disc that has improved bonding of a multiplicity of diamond particles in a binder material layer.

It is still another further object of the present invention to provide a method for conditioning a polishing pad in-situ during a CMP process by a diamond conditioning disc that is substantially without the macro-scratch defect.

### SUMMARY OF THE INVENTION

In accordance with the present invention, a method for fabricating a diamond conditioning disc and the disc fabricated are disclosed.

In a preferred embodiment, a method for fabricating a diamond conditioning disc for use in a chemical mechanical polishing apparatus can be provided which includes the steps of providing a substrate for the diamond conditioning disc; coating a layer of a binder material on top of the diamond conditioning disc; and implanting a multiplicity of diamond particles in the layer of binder material such that not more than ⅔ of a diameter of the multiplicity of diamond particles is exposed above a top surface of the layer of binder material.

The method for fabricating a diamond conditioning disc for use in a CMP apparatus may further include the step of implanting the multiplicity of diamond particles in the layer of binder material while the binder material is still in a fluid state. The method may further include the step of fabricating the binder material with a mixture of Ni and Cr. The method may further include the step of implanting the multiplicity of diamond particles such that between about ½ and about ⅔ of a diameter of the particles is exposed above a top surface of the binder material layer, or the step of implanting the multiplicity of diamond particles such that not more than ⅔ of a height of the multiplicity of the diamond particles is exposed, or the step of implanting the multiplicity of diamond particles such that between about ½ and about ⅔ of a height of the particles is exposed.

The present invention is further directed to a diamond conditioning disc that has improved bonding of a multiplicity of diamond particles in a binder material layer which includes a substrate for the diamond conditioning disc; a layer of a binder material on top of the substrate; and a multiplicity of diamond particles partially embedded in the layer of binder material with not more than ⅔ of a diameter of the multiplicity of diamond particles protruding above a top surface of the layer of binder material.

In the diamond conditioning disc that has improved bonding of a multiplicity of diamond particles in a binder material, the binder material may include an alloy of Ni and Cr. The multiplicity of diamond particles that are partially embedded in the layer of binder material with between about ½ and about ⅔ of a diameter of the particle protruding above a top surface of the layer of binder material, the multiplicity of diamond particles are partially embedded in the layer of binder material with between about ½ and about ⅔ of a height of the particles protruding above the binder material layer. The multiplicity of diamond particles are partially embedded in the layer of binder material with at least ⅓ of a diameter of the multiplicity of diamond particles embedded in the layer of binder material, or with at least ⅓ of a height of the multiplicity of diamond particles embedded in the layer of binder material.

The present invention is still further directed to a method for conditioning a polishing pad in-situ in a chemical mechanical polishing process by a diamond conditioning disc that is substantially without diamond scratching defect which can be carried out by the operating steps of providing a diamond conditioning disc that includes a substrate, a layer of binder material on top of the substrate and a multiplicity of diamond particles embedded in the layer of binder material with not more than ⅔ of a diameter of substantially all of the multiplicity diamond particles protruding above a top surface of the layer of binder materials; conducting a chemical mechanical polishing process by engaging an active surface of a rotating semiconductor wafer to a top surface of a rotating polishing pad; and engaging a top surface of the diamond conditioning disc while being rotated to the top surface of the rotating polishing pad performing pad conditioning.

The method for conditioning a polishing pad in-situ in a chemical mechanical polishing process by a diamond conditioning disc may further include the step of embedding the multiplicity of diamond particles in the layer of binder material with between about ½ and about ⅔ of a diameter of the particles protruding above the layer of binder material, or with between about ½ and about ⅔ of a height of the particles protruding above the layer of binder material. The method may further include the step of fabricating the binder material with an alloy that includes Ni and Cr.

### BRIEF DESCRIPTION OF THE DRAWINGS

These and other objects, features and advantages of the present invention will become apparatus from the following detailed description and the appended drawings in which:

FIG. 1A is a perspective view of a conventional chemical mechanical polishing apparatus illustrating polishing pads and conditioning pads.

FIG. 1B is a cross-sectional view of a polishing pad engaging a wafer in the apparatus of FIG. 1A.

FIG. 1C is an enlarged, cross-sectional view showing the interaction between the wafer surface, the polishing pad surface and the slurry in the conventional apparatus of FIG. 1A.

FIG. 2A is a perspective view showing a polishing pad and a conditioning disc of the conventional CMP apparatus of FIG. 1A.

FIG. 2B is a cross-sectional view of a conventional diamond conditioning disc illustrating diamond particles embedded in an alloy layer of nickel and chromium.

FIGS. 3A-3C illustrate cross-sectional views and a top view of a wafer suffered from a macro-scratch.

FIG. 4 is an enlarged, cross-sectional view of the present invention diamond conditioning disc.

FIG. 5 is a graph illustrating the effectiveness of the present invention diamond conditioning disc in the reduction of macro-scratches.

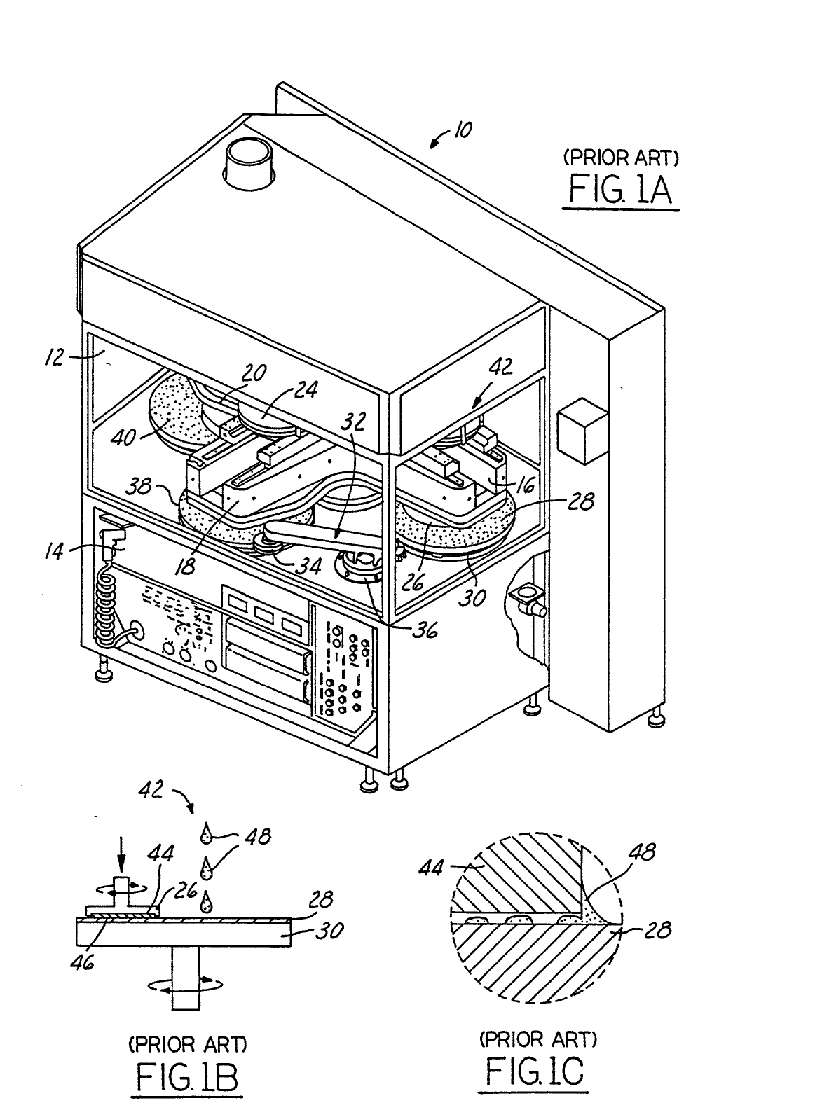

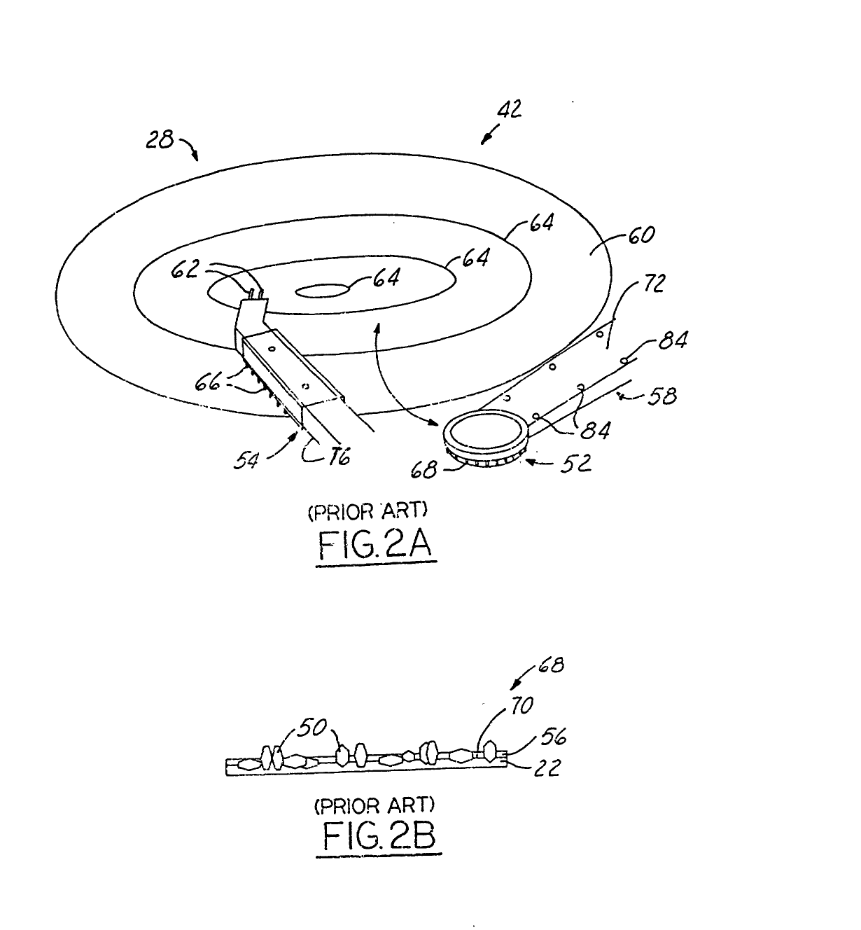

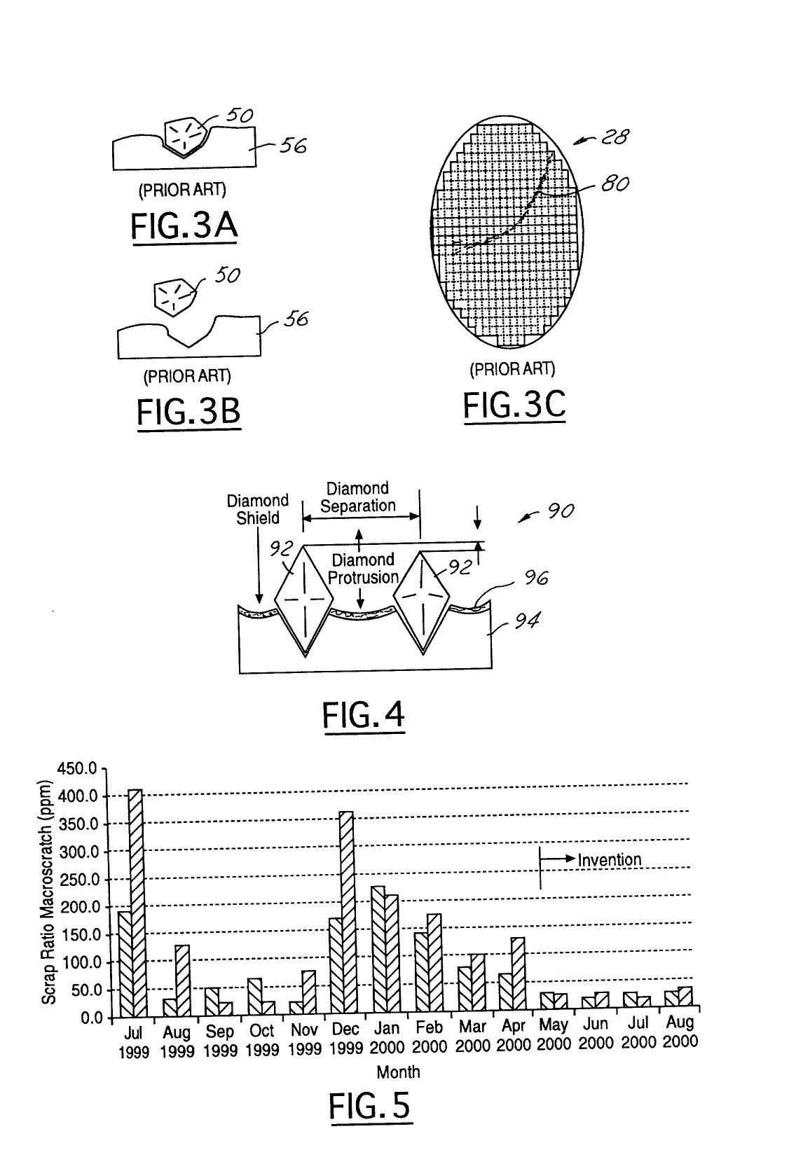

### DETAILED DESCRIPTION OF THE PREFERRED EMBODIMENT

The invention discloses a method for fabricating a diamond conditioning disc for use in a chemical mechanical polishing apparatus wherein the disc has improved holding capability of diamond particles to eliminate diamond macro-scratch problems.

The method can be carried out by first providing a substrate for the diamond conditioning disc, then coating a layer of a binder material, i.e., such as an alloy of nickel and chromium on top of the diamond conditioning disc, and implanting a multiplicity of diamond particles in the layer of binder material such that not more than ⅔ of a diameter of the particles is exposed above a top surface of the layer of binder material. The multiplicity of diamond particles may further be implanted in the binder material with between about ½ and about ⅔ of a height of the particles protruding above the binder material layer.

The invention further discloses a diamond conditioning disc that has improved bonding of a multiplicity of diamond particles in a binder material layer which includes a substrate for the disc, a layer of a binder material on top of the substrate, and a multiplicity of diamond particles partially embedded in the layer of binder material with not more than ⅔ of a diameter, or a height of the multiplicity of diamond particles protruding above a top surface of the layer of binder material. The binder material may be suitably formed of nickel or an alloy of nickel and chromium.

The invention provides a method for reducing CMP diamond disc scratch, or macro-scratch which may lead to the scrap of the complete wafer after a CMP process has been conducted on the wafer. The method limits the height of a diamond particle embedded in a binder material to at least ⅓ of the total height of the diamond particle, and preferably between about ⅓ and about ½ of the height or the diameter of the diamond particle. The present invention novel method therefore substantially prevents fracture of diamond particles due to the conditioning stress when engaging a polishing pad, while retaining the removal efficiency of the polishing pad. The lifetime of a diamond disc is thus retained while simultaneously achieving an optimized removal rate from the polishing pad.

The diamond particles can either be implanted into a layer of a binder material, while the binder material is still in a fluid state, or may be mixed with a liquid binder material first and then applied to a substrate surface. In either method, the diamond disc surface is then measured at 20 random points to check the height of the diamond particles protruding above the binder material layer. In order to achieve the present invention novel conditioning disc with the diamond particles exposed not more than ⅔ of its total height above the binder material, the height of the diamond particles measured at all 20 points must be within the ½ to ⅔ range desired.

It should be noted that when the diamond particles supplied are more in a rounded shape, the diameter of the particles is used as a measurement for the protruding portion. When the diamond particles are more of a pointed type, as shown in FIG. 4, the height of the diamond particle is used as the measurement.

Referring now to FIG. 4, wherein an enlarged, cross-sectional view of a present invention diamond conditioning disc 90 is shown. The diamond particles 92 are embedded in a binder material layer 94 the height of the diamond particles 92 protruding above, or exposed above the top surface 96 of the binder material layer 94 is less than ⅔ of the height of the particles. In a preferred embodiment of the present invention, the height of the particles 92 exposed should be within a range of between about ½ and about ⅔ of the total height of the particles. When such geometry is maintained in the present invention diamond conditioning disc, the loss of diamond particles from the disc is greatly reduced. Defect such as the macro-scratch of a wafer surface can thus be prevented.

The effectiveness of the present invention novel method and the disc fabricated by the method is shown in FIG. 5, it is seen that after the present invention novel method was implemented, the scratch ratio by macro-scratches occurring per month is drastically reduced by at least ten fold.

The present invention method for fabricating a diamond conditioning disc without the wafer macro-scratch problem and the disc fabricated have therefore been described in the above description and in the appended drawings of FIGS. 4 and 5.

While the present invention has been described in an illustrative manner, it should be understood that the terminology used is intended to be in a nature of words of description rather than of limitation.

Furthermore, while the present invention has been described in terms of a preferred embodiments, it is to be appreciated that those skilled in the art will readily apply these teachings to other possible variations of the inventions.

The embodiment of the invention in which an exclusive property or privilege is claimed are defined as follows.

What is claimed is:

1. A method for fabricating a diamond conditioning disc for use in a chemical mechanical polishing apparatus comprising the steps of:
providing a substrate for said diamond conditioning disc;
coating a layer of a binder material on top of said diamond conditioning disc; and
implanting a multiplicity of diamond particles in said layer of binder material such that not more than ⅔ of a diameter of said multiplicity of diamond particles is exposed above a top surface of said layer of binder material.

2. A method for fabricating a diamond conditioning disc for use in a CMP apparatus according to claim 1 further comprising the step of implanting said multiplicity of diamond particles in said layer of binder material while said binder material is still in a fluid state.

3. A method for fabricating a diamond conditioning disc for use in a CMP apparatus according to claim 1 further comprising the step of fabricating said binder material by a mixture of Ni and Cr.

4. A method for fabricating a diamond conditioning disc for use in a CMP apparatus according to claim 1 further comprising the step of implanting said multiplicity of diamond particles such that between about ½ and about ⅔ of a diameter of said particles is exposed above a top surface of said layer of binder material.

5. A method for fabricating a diamond conditioning disc for use in a CMP apparatus according to claim 1 further comprising the step of implanting said multiplicity of diamond particles such that not more than ⅔ of a height of said multiplicity of diamond particles is exposed above a top surface of said layer of binder material.

6. A method for fabricating a diamond conditioning disc for use in a CMP apparatus according to claim 1 further comprising the step of implanting said multiplicity of diamond particles such that between about ½ and about ⅔ of a height of said particles is exposed above a top surface of said layer of binder material.

7. A diamond conditioning disc having improved bonding of a multiplicity of diamond particles in a binder material layer comprising:
a substrate for said diamond conditioning disc;
a layer of a binder material on top of said substrate; and
a multiplicity of diamond particles partially embedded in said layer of binder material with not more than ⅔ of a diameter of said multiplicity of diamond particles protruding above a top surface of said layer of binder material.

8. A diamond conditioning disc having improved bonding of a multiplicity of diamond particles in a binder material according to claim 7, wherein aid binder material comprises an alloy of Ni and Cr.

9. A diamond conditioning disc having improved bonding of a multiplicity of diamond particles in a binder material according to claim 7, wherein said multiplicity of diamond particles partially embedded in said layer of binder material with between about ½ and about ⅔ of a diameter of said particles protruding above a top surface of said layer of binder material.

10. A diamond conditioning disc having improved bonding of a multiplicity of diamond particles in a binder material according to claim 7, wherein said multiplicity of diamond particles partially embedded in said layer of binder material with between about ½ and about ⅔ of a height of said particles protruding above a top surface of said layer of binder material.

11. A diamond conditioning disc having improved bonding of a multiplicity of diamond particles in a binder material according to claim 7, wherein said multiplicity of diamond particles partially embedded in said layer of binder material with at least ⅓ of a diameter of said multiplicity of diamond particles embedded in said layer of binder material.

12. A diamond conditioning disc having improved bonding of a multiplicity of diamond particles in a binder material according to claim 7, wherein said multiplicity of diamond particles partially embedded in said layer of binder material with at least ⅓ of a height of said multiplicity of diamond particles embedded in said layer of binder material.

13. A method for conditioning a polishing pad in-situ in a chemical mechanical polishing process by a diamond conditioning disc substantially without diamond scratching defect comprising the steps of:
providing a diamond conditioning disc comprising a substrate, a layer of binder material on top of said substrate and a multiplicity of diamond particles embedded in said layer of binder material with not more than ⅔ of a diameter of substantially all said multiplicity of diamond particles protruding above a top surface of said layer of binder material;
conducting a chemical mechanical polishing process by engaging an active surface of a rotating semiconductor wafer to a top surface of a rotating polishing pad; and
engaging a top surface of the diamond conditioning disc while being rotated to said top surface of the rotating polishing pad performing pad conditioning.

14. A method for conditioning a polishing pad in-situ in a chemical mechanical polishing process by a diamond conditioning disc substantially without diamond scratching defect according to claim 13 further comprising the step of embedding said multiplicity of diamond particles in said layer of binder material with between ½ and ⅔ of a diameter of the particles protruding above said layer of binder material.

15. A method for conditioning a polishing pad in-situ in a chemical mechanical polishing process by a diamond conditioning disc substantially without diamond scratching defect according to claim 13 further comprising the step of embedding said multiplicity of diamond particles in said layer of binder material with between ½ and ⅔ of a height of the particles protruding above said layer of binder material.

16. A method for conditioning a polishing pad in-situ in a chemical mechanical polishing process by a diamond conditioning disc substantially without diamond scratching defect according to claim 13 further comprising the step of fabricating said binder material with an alloy comprises Ni and Cr.
